(19) United States
(12) Patent Application Publication
(10) Pub. No.: US 2025/0269692 A1
(43) Pub. Date: Aug. 28, 2025

(54) Trailer Lock

(71) Applicant: Hui YE, Zhejiang (CN)

(72) Inventor: Hui YE, Zhejiang (CN)

(21) Appl. No.: 19/025,648

(22) Filed: Jan. 16, 2025

(30) Foreign Application Priority Data
Feb. 26, 2024 (CN) 202420347217.9

(51) Int. Cl. B60D 1/60; B60D 1/06

(52) U.S. Cl. CPC B60D 1/60; B60D 1/06

(57) ABSTRACT

The present disclosure provides a trailer lock, which comprises a lock body and a U-shaped lock rod, wherein a lock rod hole penetrating vertically is formed on both sides of the lock body for insertion and fitting of the U-shaped lock rod; a lock cylinder is provided on the lock body for controlling the locking and unlocking of the U-shaped lock rod; an alarm module is installed in the lock body, a rotatable coupler is further disposed outside the lock body, and the coupler has a first position and a second position; the alarm module is turned on when it is in a first position, and turned off when it is turned to a second position.

### CROSS-REFERENCE TO RELATED APPLICATIONS

This application claims the priority of China Patent Application No. 202420347217.9 filed on Feb. 26, 2024, entitled “Trailer Lock”, all the contents and amendments of which are incorporated into this application by reference.

### TECHNICAL FIELD

The present disclosure relates to the technical field of trailer locks, particularly to a trailer lock.

### BACKGROUND

Trailer lock is a kind of mechanical lock, which is usually used to lock the connecting parts of trailer, such as trailer ball cover and trailer hook, to prevent the trailer from being stolen or illegally used. It mainly realizes the locking and unlocking functions through the interaction of lock body, lock, lock rod and other parts.

For example, in the existing China patents, the utility model patent No. CN206071289U discloses a trailer lock with an alarm device. By setting a buzzer alarm in the trailer lock, if the trailer lock encounters violent damage, such as lock picking, the alarm device will give a buzzer alarm to scare off thieves in time and ensure property safety.

However, the patent has the following disadvantages: the alarm device of trailer lock cannot be conveniently opened or closed manually; Moreover, the alarm device of this patent can disassemble the electronic components by tools such as screwdriver without triggering the alarm, that is, the thief can easily make the trailer lock with the alarm device lose the alarm function.

Therefore, there is a need to propose a new type of trailer lock, which can facilitate the opening or closing of the alarm device and prevent thieves from dismantling the alarm device.

### SUMMARY

The present disclosure provides a trailer lock to solve the problems mentioned in the background art.

In order to achieve the object of the present disclosure, the present disclosure adopts the following technical solution:

A trailer lock includes a lock body and a U-shaped lock rod, wherein a lock rod hole penetrating vertically is formed on both sides of the lock body for insertion and fitting of the U-shaped lock rod, and a lock cylinder is provided on the lock body for controlling locking and unlocking of the U-shaped lock rod, wherein an alarm module is installed inside the lock body, a rotatable coupler is further disposed outside the lock body, and the coupler has a first position and a second position; and wherein, when the coupler rotates to the first position, the alarm module is in an on state, and when the coupler rotates to the second position, the alarm module is in an off state.

The present disclosure further provides a trailer lock, which includes a lock body and a coupler, wherein the lock body has at least one accommodating cavity and is provided with an alarm module, and the coupler is rotatably installed on the lock body and has a first position and a second position; and at least one end of the coupler extends into the accommodating cavity, a switch mechanism is disposed between the coupler and the alarm module, and the alarm module is turned on or off by the switch mechanism; and wherein, when the coupler rotates to the first position, the alarm module is set to an on state by the switch mechanism; and when the coupler rotates to the second position, the alarm module is set to an off state by the switch mechanism.

The present disclosure further provides a trailer lock, which includes a lock body and a coupler which can be connected with traction equipment, wherein the lock body has at least one accommodating cavity and is provided with an alarm module, and the coupler is rotatably installed on the lock body; and at least one end of the coupler extends into the accommodating cavity, and a switch mechanism is disposed between the coupler and the alarm module; and wherein, when the coupler rotates, the coupler turns on or off the alarm module by the switch mechanism; and the accommodating cavity is provided with an upper cover and closes the accommodating cavity, and a connector for fixing the upper cover is disposed between the upper cover and the lock body; and the connector is disposed close to the coupler, and when the coupler is connected with the traction equipment, the connector is shielded by the traction equipment.

### BRIEF DESCRIPTION OF DRAWINGS

The drawings, which constitute a part of this application, are used to provide a further understanding of the present disclosure. The illustrative embodiments of the present disclosure and the descriptions thereof are used to explain the present disclosure, and do not constitute undue limitations on the present disclosure. In the drawings:

FIG. 1 is a perspective view of the present disclosure;

FIG. 2 is an explosion schematic diagram of the present disclosure;

FIG. 3 is a schematic diagram of partial explosion of the present disclosure;

FIG. 4 is a schematic diagram of the connection between the coupler and the paddle;

FIG. 5 is a top view of the present disclosure;

FIG. 6 is a sectional view taken at A-A in FIG. 5;

FIG. 7 is the structural schematic diagram of the lock cylinder, lock bolt and spring.

Reference signs: U-shaped lock rod (1); Lock slot (101); Upper cover (2); Positioning hole (21); A Coupler (3); Paddle (4); Screw (5); Alarm module (6); Contact switch (61); Lock body (7); Lock rod hole (71); Accommodating cavity (72); Positioning post (73); Lock bolt (8); Spring (9); Lock cylinder (10); Key (11).

### DESCRIPTION OF EMBODIMENTS

The technical solution in the embodiment of the present disclosure will be clearly and completely described below with reference to the drawings. Obviously, the described embodiment is part of, rather than all of the embodiments of the present disclosure. The following description of at least one exemplary embodiment is illustrative in nature and is in no way intended to limit the present disclosure, its application or uses. Based on the embodiments in the present disclosure, all other embodiments obtained by those skilled in the art without creative work belong to the scope of protection of the present disclosure.

It should be noted that the terminology used here is only for describing specific embodiments, and is not intended to limit exemplary embodiments according to the present application. As used herein, the singular form is also intended to include the plural form unless the context clearly indicates otherwise. Furthermore, it should be appreciated that when the terms “comprising” and/or “including” are used in this specification, they specify the presence of features, steps, operations, devices, components and/or combinations thereof.

Unless otherwise specified, the relative arrangement of components and steps, numerical expressions and numerical values set forth in these embodiments do not limit the scope of the present disclosure. At the same time, it should be appreciated that for the convenience of description, the dimensions of various parts shown in the drawings are not drawn according to the actual scale relationship. Techniques, methods and equipment known to those skilled in the art may not be discussed in detail, but in appropriate cases, they should be regarded as part of the authorization specification. In all the examples shown and discussed herein, any specific values should be interpreted as illustrative, and not as limiting. Therefore, other examples of exemplary embodiments may have different values. It should be noted that similar numbers and letters indicate similar items in the following drawings, therefore once an item is defined in one drawing, it does not need to be further discussed in subsequent drawings.

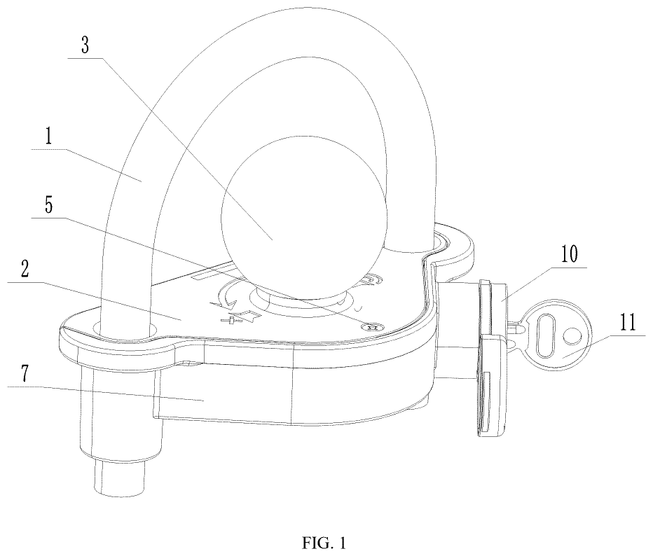

As shown in FIG. 1 to FIG. 7, a trailer lock includes a lock body 7 and a U-shaped lock rod 1. Lock rod holes 71 penetrating vertically are formed on both sides of the lock body 7 for the insertion and fitting of the U-shaped lock rod 1. A lock cylinder 10 is disposed on the lock body 7 for controlling the locking and unlocking of the U-shaped lock rod 1. An alarm module 6 is installed inside the lock body 7, and a rotatable coupler 3 is disposed outside the lock body 7. The coupler 3 has a first position and a first position. When the coupler 3 rotates to the first position, the alarm module 6 is turned on, and when the coupler 3 rotates to the second position, the alarm module 6 is turned off.

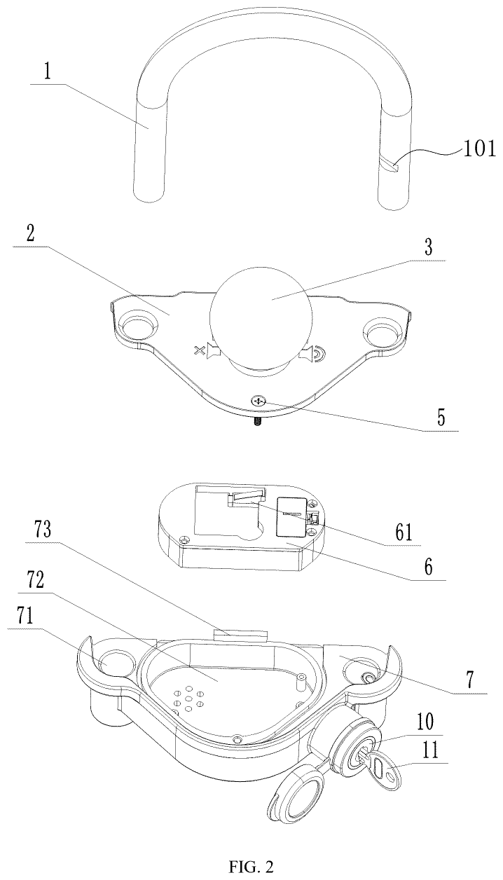

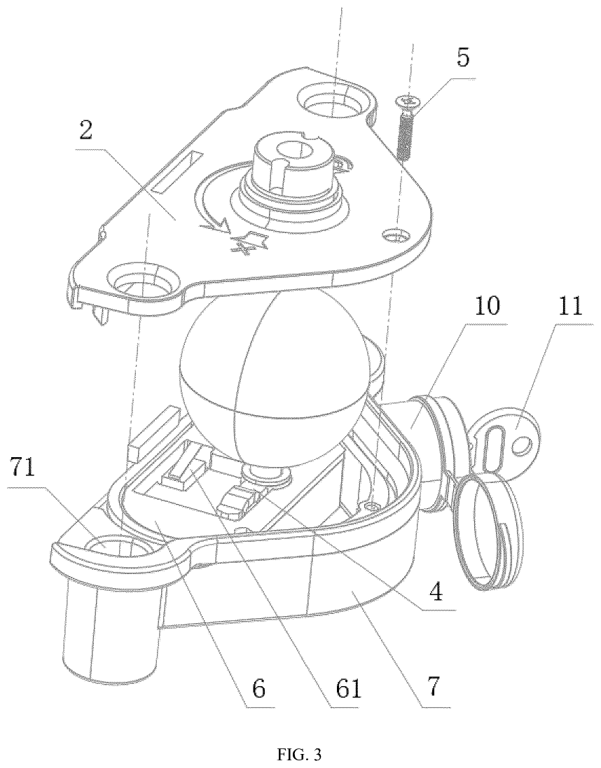

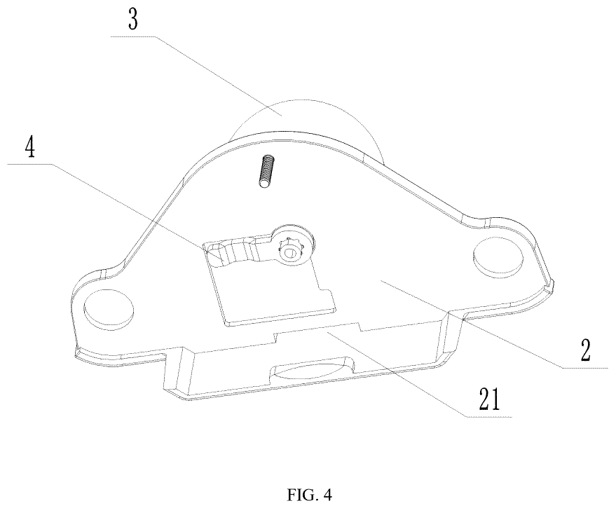

Please refer to FIG. 2, FIG. 3 and FIG. 4, in this embodiment, the lock body 7 has an accommodating cavity 72 with an upper cover 2. The accommodating cavity 72 is used to install the alarm module 6. The accommodating cavity 72 is closed by the upper cover 2. The closed accommodating cavity 72 can ensure that the alarm module 6 is not disturbed and destroyed by the external environment. The alarm module 6 is provided with a switch mechanism, which is a contact switch 61. The coupler 3 penetrates the upper cover 2 and extends to the alarm module 6, and is rotatably connected with the upper cover 2. The coupler 3 is provided with a paddle 4 located at one side of a contact switch 61, and the paddle 4 rotates synchronously with the coupler 3 when the coupler 3 is rotated, and the contact switch 61 is located within the rotation range of the paddle 4.

When the coupler 3 rotates to the first position, the paddle 4 abuts against the contact switch 61, and the alarm module 6 is turned on. On the contrary, if the user wants to temporarily turn off the alarm function, he only needs to rotate the coupler 3 to the second position. In this state, the paddle 4 is out of contact with the contact switch 61, and the alarm module 6 is turned off. This design provides users with selectivity and increases the flexibility of use. Users can freely choose to turn on or off the alarm module 6 according to different usage scenarios and security requirements. For example, in an environment that needs vigilance, the user can keep the alarm module 6 on to ensure that the trailer lock can trigger the alarm immediately when it is damaged by external force, while in some relatively safe or silent environments, the user can turn off the alarm module 6 to avoid unnecessary interference or false alarm.

In other embodiments (not shown), the switch mechanism can also be a pressure sensor, a toggle switch and the like. When the pressure sensor is used, when the coupler 3 rotates, the paddle 4 presses against the pressure sensor, triggering the opening or closing of the alarm module 6. When a toggle switch is used, the paddle 4 of the coupler 3 is connected with the toggle switch, and the alarm module 6 is turned on or off by reciprocating rotation. Different switch mechanisms can be selected according to different requirements.

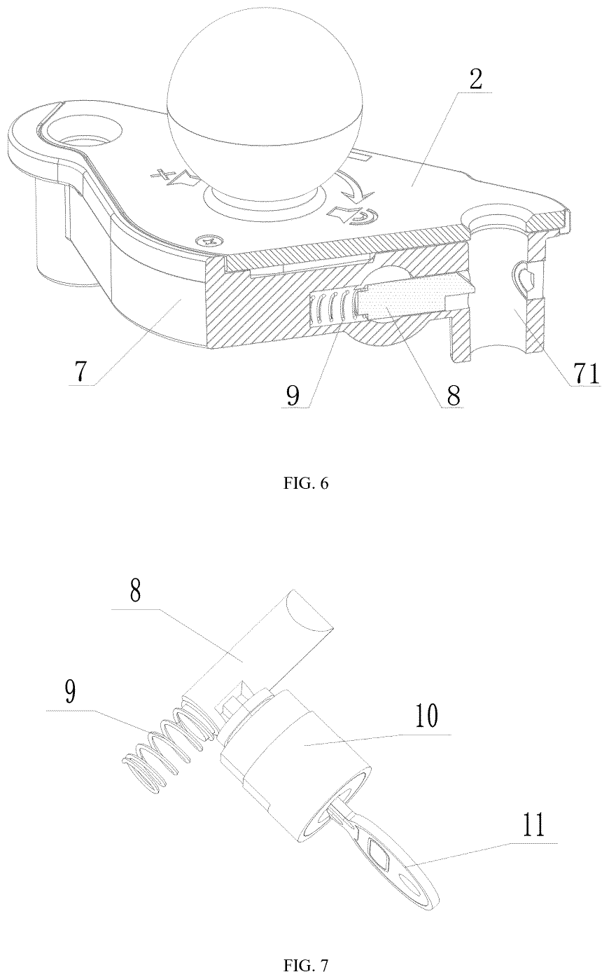

Please refer to FIG. 1, FIG. 2, FIG. 6 and FIG. 7. In this embodiment, the lock cylinder 10 is controlled by a matching key 11 to rotate, so as to lock and release the U-shaped lock rod 1. The lock body 7 is also internally provided with a lock bolt 8 and a spring 9 for supporting the lock bolt 8. The lock bolt 8 is controlled by the lock cylinder 10 to move axially, and can run into the lock rod hole 71. A lock slot 101 is formed at one end of the U-shaped lock rod 1 corresponding to the lock bolt 8. When the U-shaped lock rod 1 is installed, the U-shaped lock rod 1 is inserted into the lock rod hole 71. When the U-shaped lock rod 1 contacts the lock bolt 8, the lock bolt 8 is squeezed and slides in the direction of the spring 9, and the spring 9 is compressed. When the lock bolt 8 directly faces the lock slot 101, the spring 9 pushes the lock bolt 8 out and inserts it into the lock slot 101, and the U-shaped lock rod 1 is locked by the lock bolt 8 at this time. When it is necessary to remove the U-shaped lock rod 1, the matching key 11 is inserted into the lock cylinder 10 and rotated toward the spring 9. At this time, the lock cylinder 10 rotates to drive the lock bolt 8 to slide towards the spring 9, and the lock bolt 8 is disengaged from the U-shaped lock rod 1 in the lock slot 101 to unlock, so that the U-shaped lock rod 1 can be taken out from the lock rod hole 71.

In another embodiment (not shown), the U-shaped lock rod 1 may be provided with a plurality of lock slots 101 along the length direction, so that the trailer lock can be adapted to more traction devices with different specifications and models, and the universality and adaptability of the trailer lock are improved.

In other embodiments (not shown), the unlocking mode of the lock cylinder 10 may also be fingerprint lock, rotary password lock, electronic password lock and hybrid unlocking mode (fingerprint+electronic password), which provides various unlocking modes to meet the needs of different users. With different unlocking solutions, a safer and more convenient unlocking method is provided. These alternatives not only enhance the adaptability of the lock, but also enhance the user experience, which can better meet diverse needs. Different unlocking methods can be selected according to actual needs, making the trailer lock more diversified in terms of safety, convenience and applicability.

In another embodiment (not shown), the alarm module 6 is linked with the lock cylinder 10. The alarm module 6 has a trigger switch that can trigger the alarm of the alarm module 6, and the trigger switch has a linked state and a decoupled state. When the trigger switch is in the linked state, the trigger switch is connected with the lock cylinder 10, and when the trigger switch is in the decoupled state, the trigger switch is disconnected from the lock cylinder 10. When the alarm module 6 is turned on, the trigger switch is in a linked state, and when the lock cylinder 10 is forced to rotate in an unlocked state, the trigger switch will be pressed, thereby triggering the alarm module 6 and giving an alarm. When the alarm module 6 is turned off, the trigger switch is in a decoupled state, and the alarm module 6 will not be triggered when the lock cylinder 10 is rotated in an unlocked state.

In another embodiment (not shown), the difference between this embodiment and the above-mentioned embodiment is that the alarm module 6 is always on, and the trigger switch has a triggerable state and a non-triggerable state. When the trailer lock is in the locked state, the trigger switch is in the triggerable state, and when the lock cylinder 10 is forced to move, the lock cylinder 10 triggers the trigger switch, thus triggering the alarm module 6 to give an alarm. When the trailer lock is in the unlocked state, the trigger switch is in the non-triggerable state, and the alarm module 6 will not be triggered by screwing the lock cylinder 10.

In another embodiment (not shown), the turning-on and turning-off of the alarm module may also be linked with the lock cylinder 10, for example, by continuously rotating the lock cylinder 10 twice to turn on the alarm module 6, and rotating the lock cylinder 10 again to turn off the alarm module 6 once, so as to control the on and off of the alarm module 6 circularly.

Please refer to FIG. 1 and FIG. 2, in this embodiment, the coupler 3 is used for interconnection with the traction equipment, and the upper part of the coupler 3 is ball-shaped to adapt to the traction equipment.

In other embodiments (not shown), the upper ball head of the coupler 3 can be designed to be detachably connected, and ball heads with different sizes, such as 2 inches, 2.5 inches, etc., can be designed to meet the diversified requirements in different application scenarios. In the actual use process, users can choose the appropriate ball head for installation according to their own needs and scenes. This detachable and multi-specification design not only improves the universality and practicability of the coupler 3, but also brings users a more convenient and personalized use experience.

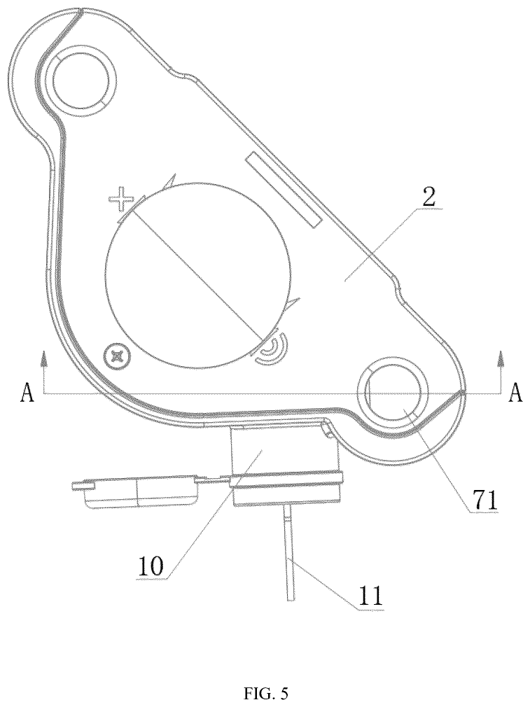

Please refer to FIG. 2, FIG. 3 and FIG. 5, in this embodiment, the lock body 7 is provided with an integrally formed positioning post 73, which is rectangular. The upper cover 2 has a positioning hole 21 matched with the positioning post 73. The upper cover 2 and the lock body 7 are fixedly connected by a connector, which is a screw 5. The screw 5 and the positioning post 73 are respectively distributed on both sides of the coupler 3. When installing the upper cover 2, the initial positioning of the upper cover 2 and the lock body 7 can be realized only by aligning the positioning hole 21 with the positioning post 73. Then, the upper cover 2 and the lock body 7 can be tightly fixed together by screwing up the screw 5. This design not only simplifies the installation process, but also improves the overall stability of the trailer lock. When the coupler 3 of the trailer lock and the coupler on the traction equipment are coupled and locked, the traction equipment will cover the screw 5 and the positioning post 73 in a hidden state, so that it is difficult for thieves to dismantle the alarm function by using a screwdriver, which effectively prevents thieves from disassembling the alarm module 6 and improves the anti-theft performance.

In another embodiment (not shown), the bottom of the lock body 7 is provided with a battery compartment, which is closed by a battery compartment cover plate. The battery compartment cover plate, the lock body 7 and the upper cover 2 are fixedly connected by screws 5. The screws 5 are installed from the upper cover and connected with the battery compartment cover plate after passing through the lock body 7. The screws 5 are distributed on both sides of the coupler 3. When the coupler 3 of the trailer lock and the coupler on the traction equipment are coupled and locked, the traction equipment will cover the screw 5 and the positioning post 73 in a hidden state, so that it is difficult for a thief to dismantle it with a screwdriver to achieve the purpose of destroying the alarm function first, effectively preventing the thief from disassembling the alarm module 6, improving the anti-theft performance and facilitating the replacement of the battery.

In another embodiment (not shown), the accommodating cavity 72 is disposed at the bottom of the lock body 7. The accommodating cavity 72 is provided with a lower cover for closing the accommodating cavity 72. The lower cover and the lock body 7 are installed from the upper part of the lock body 7 and connected with the lower cover after passing through the lock body 7. The screws 5 are distributed on both sides of the coupler 3. When the coupler 3 of the trailer lock and the coupler on the traction equipment are coupled and locked, the traction equipment will cover the screw 5 and the positioning post 73 in a hidden state, so that it is difficult for a thief to dismantle it with a screwdriver to achieve the purpose of destroying the alarm function first, effectively preventing the thief from disassembling the alarm module 6, and improving the anti-theft performance.

In another embodiment (not shown), the positioning post 73 may be provided with an inverted buckle, and an inverted buckle groove can be provided in the positioning hole 21. When the positioning post 73 is inserted into the positioning hole 21, the inverted buckle will be caught in the inverted buckle groove to make the connection between the upper cover 2 and the lock body 7 more compact and firm. The shape of the positioning post 73 can be geometric shapes such as circle and triangle, and the number can also be one or more.

In other embodiments (not shown), the upper cover 2 and the lock body 7 may also be connected by means of fixed snap connection, chute clamping, etc. The connector can be a buckle, a magnetic hook and the like. Alternatively, the positioning post 73 can be replaced by a screw 5, and the upper cover 2 and the lock body 7 are fixed by two screws 5, which have better locking and fixing performance.

In conclusion, as can be seen from the above description, the present disclosure has achieved the following technical effects:

the alarm module 6 is built in the accommodating cavity 72, and the accommodating cavity 72 is closed by the upper cover 2; the upper cover 2 is connected with the lock body 7 by the screw 5; when the trailer is locked on the traction equipment, the screw 5 is hidden by the traction equipment, so that it is difficult for a thief to dismantle it with a screwdriver to achieve the purpose of destroying the alarm function first, effectively preventing the thief from disassembling the alarm module 6, improving the anti-theft performance; the switch of the alarm module 6 may also be controlled by rotating the coupler 3, thus increasing the flexibility of use; And that disclosure has the advantage of simple structure, few parts and convenient assembly.

In the description of the present disclosure, it should be appreciated that the orientation or positional relationship indicated by orientation words such as “front, back, upper, lower, left, right”, “lateral, vertical, horizontal” and “top, bottom” are usually based on the orientation or positional relationship shown in the attached drawings, just for the convenience of describing the present disclosure and simplifying the description. Unless otherwise stated, these orientation words do not indicate or imply that the device or element referred to must have a specific orientation or be constructed and operated in a specific orientation, therefore they cannot be construed as limiting the scope of protection of the present disclosure. The orientation words “inside and outside” refer to the inside and outside relative to the outline of each component itself.

For the convenience of description, spatially relative terms such as “above”, “on”, “on the upper surface of” and “upper” can be used here to describe the spatial positional relationship between a device or feature as shown in the drawings and other devices or features. It should be appreciated that spatially relative terms are intended to encompass different orientations in use or operation in addition to the orientation of the device depicted in the drawings. For example, if the devices in the drawings are inverted, devices described as “above” or “on” other devices or structures will be positioned as “below” or “under” other devices or structures. Thus, the exemplary term “above” can include both orientation of “above” and “below”. The device can also be positioned in other different ways (rotated by 90 degrees or in other orientations), and the spatial relative description used here is explained accordingly.

In addition, it should be noted that the words “first” and “second” are used to define parts for the convenience of distinguishing the corresponding parts. Unless otherwise stated, the above words have no special meaning, and thus they cannot be construed as limiting the protection scope of the present disclosure.

What has been described above is only the preferred embodiment of the present disclosure, and it is not intended to limit the present disclosure. For those skilled in the art, the present disclosure may have various modifications and changes. Any modification, equivalent substitution, improvement and the like made within the spirit and principle of the present disclosure shall fall into the protection scope of the present disclosure.

What is claimed is:

1. A trailer lock, comprising a lock body and a U-shaped lock rod, wherein a lock rod hole penetrating vertically is formed on both sides of the lock body for insertion and fitting of the U-shaped lock rod, and a lock cylinder is provided on the lock body for controlling locking and unlocking of the U-shaped lock rod, wherein
an alarm module is installed inside the lock body, a rotatable coupler is further disposed outside the lock body, and the coupler has a first position and a second position; and
wherein, when the coupler rotates to the first position, the alarm module is in an on state, and when the coupler rotates to the second position, the alarm module is in an off state.

2. The trailer lock according to claim 1, wherein the lock body has at least one accommodating cavity with an upper cover, and the accommodating cavity is configured for installing the alarm module and is closed by the upper cover.

3. The trailer lock according to claim 2, wherein the alarm module is provided with a contact switch, the coupler penetrates through the upper cover and extends to the alarm module, and the coupler is rotatably connected with the upper cover.

4. The trailer lock according to claim 3, wherein the coupler is provided with a paddle located at a side of the contact switch, the paddle is capable of rotating synchronously with the coupler, and the contact switch is located within a rotation range of the paddle.

5. The trailer lock according to claim 4, wherein when the coupler rotates to the first position, the paddle abuts against the contact switch, and the alarm module is turned on.

6. The trailer lock according to claim 5, wherein when the coupler rotates to the second position, the paddle is out of contact with the contact switch, and the alarm module is turned off.

7. The trailer lock according to claim 1, wherein the lock cylinder is controlled to rotate by a matched key to lock or release the U-shaped lock rod.

8. The trailer lock according to claim 7, wherein a lock bolt and a spring supporting the lock bolt are further disposed inside the lock body, and the lock bolt is controlled to move axially by the lock cylinder.

9. The trailer lock according to claim 8, wherein the lock bolt is able to run into at least one lock rod hole, and a lock slot is formed at one end of the U-shaped locking rod corresponding to the lock bolt.

10. The trailer lock according to claim 1, wherein the coupler is configured for interconnection with traction equipment, and an upper part of the coupler is ball-shaped.

11. The trailer lock according to claim 2, wherein the lock body is provided with a positioning post that is integrally formed, and the upper cover is provided with a positioning hole matched with the positioning post.

12. The trailer lock according to claim 11, wherein the upper cover and the lock body are fixedly connected by a screw.

13. The trailer lock according to claim 12, wherein the screw and the positioning post are respectively distributed on both sides of the coupler.

14. A trailer lock, comprising a lock body and a coupler, wherein
the lock body has at least one accommodating cavity and is provided with an alarm module, and the coupler is rotatably installed on the lock body and has a first position and a second position; and
at least one end of the coupler extends into the accommodating cavity, a switch mechanism is disposed between the coupler and the alarm module, and the alarm module is turned on or off by the switch mechanism; and
wherein, when the coupler rotates to the first position, the alarm module is set to an on state by the switch mechanism; and
when the coupler rotates to the second position, the alarm module is set to an off state by the switch mechanism.

15. The trailer lock according to claim 14, wherein the switch mechanism comprises a paddle fixedly connected to the coupler and a contact switch disposed on the alarm module.

16. The trailer lock according to claim 15, wherein when the coupler rotates to the first position, the paddle abuts against the contact switch, and the alarm module is turned on.

17. The trailer lock according to claim 16, wherein when the coupler rotates to the second position, the paddle is out of contact with the contact switch, and the alarm module is turned off.

18. A trailer lock, comprising a lock body and a coupler which can be connected with traction equipment, wherein
the lock body has at least one accommodating cavity and is provided with an alarm module, and the coupler is rotatably installed on the lock body; and
at least one end of the coupler extends into the accommodating cavity, and a switch mechanism is disposed between the coupler and the alarm module; and
wherein, when the coupler rotates, the coupler turns on or off the alarm module by the switch mechanism; and
the accommodating cavity is provided with an upper cover and closes the accommodating cavity, and a connector for fixing the upper cover is disposed between the upper cover and the lock body; and
the connector is disposed close to the coupler, and when the coupler is connected with the traction equipment, the connector is shielded by the traction equipment.

19. The trailer lock according to claim 18, wherein the connector is disposed at one end oriented toward the traction equipment, and when the coupler is connected with the traction equipment, the connector is covered and shielded by the traction equipment.

20. The trailer lock according to claim 19, wherein the connector is a screw, and the screw is inserted between the lock body and the upper cover.
